(19) United States
(12) Patent Application Publication
(10) Pub. No.: US 2023/0297930 A1
(43) Pub. Date: Sep. 21, 2023

(54) METHOD AND SYSTEM FOR BUILDING ACTIONABLE KNOWLEDGE BASED INTELLIGENT ENTERPRISE SYSTEM

(71) Applicant: INFOSYS LIMITED, BANGALORE (IN)

(72) Inventor: BALAJI KRISHNAMACHARY IYENGAR, Pune (IN)

(21) Appl. No.: 17/709,823

(22) Filed: Mar. 31, 2022

(30) Foreign Application Priority Data
Mar. 21, 2022 (IN) 202241019410

(51) Int. Cl. G06Q 10/06; G06N 5/02

(52) U.S. Cl. CPC G06Q 10/067; G06Q 10/0633; G06Q 10/06375; G06N 5/022

(57) ABSTRACT

Embodiments of the present disclosure relates to a method and a business intelligence system for building actionable knowledge based intelligent enterprise system. The present disclosure proposes a solution which considers atomic executable process and its data as digital twins. Further, a triangulated integration of a plurality of digital twins is performed for identifying inter-process and intra-process correlation between the atomic executable process and its data. The correlation provides insights of business knowledge and helps in determining actionable business intelligence. The actionable business intelligence transforms the enterprise system into an intelligent enterprise system.

This application claims the benefit of Indian Patent Application No. 202241019410, filed Mar. 31, 2022, which is hereby incorporated by reference in its entirety.

### FIELD

The present disclosure relates in general to business intelligence systems. Particularly, but not exclusively, the present disclosure relates to method, and system for building actionable knowledge based intelligent enterprise system.

### BACKGROUND

Enterprise systems aim to modernize the technology and use latest technological tools to get business insights and actionable business information. Conventional analytical tools lacks the ability to analyze various dimensions of information, and thus the business solutions derived using conventional analytical tools are do not meet business requirements. Business Intelligence (BI) refers to technology that enables business to organize, analyze and contextualize data from around the business. BI includes multiple tools and techniques to transform raw data into meaningful actionable information. BI not only aims to transform legacy systems to modern systems, but also provides business insights by analyzing information from different domains and deriving appropriate strategy tailored to the business.

BI tools use various analysis technology such as Artificial Intelligence (AI) models. However, the AI models are as good as the data input to them. Existing enterprise systems are either process centric or data centric. Process centric systems face a challenge of migrating to newer technological platforms as the entire architectural changes needs to be made for the migration. Further, data centric approaches do not consider the data generated by processes within the enterprise system, which can be insightful in generating the business intelligence. Hence, there is a need for a solution that addresses one or more of the above problems.

The information disclosed in this background of the disclosure section is only for enhancement of understanding of the general background of the invention and should not be taken as an acknowledgment or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

In one embodiment, the present disclosure discloses a method for building an actionable knowledge based intelligent enterprise system. The method comprises identifying, by a business intelligence system, a plurality of digital sub-systems from a plurality of business processes of an enterprise system. Each of the plurality of digital sub-systems comprises a plurality of atomic business transactions, where each atomic business transaction comprises an atomic executable process that generates associated data comprising transactional data and behavioral data. The method further comprises generating, by the business intelligence system, a plurality of digital twins for each of the plurality of digital sub-systems, where each digital twin comprising a pair formed between an atomic executable process of a digital sub-system and associated data. Further, the method includes performing, by the business intelligence system, triangulated integration of the plurality of digital twins corresponding to a digital sub-system from the plurality of digital-sub-systems, for identifying intra-process and inter-process correlation between the atomic executable process and associated data constituting each of the generated plurality of digital twins. The correlation comprises generation of business knowledge by alignment of the associated data of each of the plurality of digital twins with one or more artificial intelligence (AI) based models and one or more business objectives. The method further comprises determining, by the business intelligence system, actionable business intelligence, based on the generated business knowledge, for building a knowledge based actionable intelligent enterprise system.

In one embodiment, the present disclosure discloses a Business Intelligence (BI) system for building an actionable knowledge based intelligent enterprise system. The BI system comprises one or more processors and a memory. The one or more processors are configured to identify a plurality of digital sub-systems from a plurality of business processes of an enterprise system, where each of the plurality of digital sub-systems comprises a plurality of atomic business transactions, where each atomic business transaction comprises an atomic executable process that generates associated data comprising transactional data and behavioral data; generate a plurality of digital twins for each of the plurality of digital sub-systems, where each digital twin comprises a pair formed between an atomic executable process of a digital sub-system and associated data; perform triangulated integration of the plurality of digital twins corresponding to a digital sub-system from the plurality of digital-sub-systems, for identifying intra-process and inter-process correlation between the atomic executable process and associated data constituting each of the generated plurality of digital twins, where the correlation comprises generation of business knowledge by alignment of the associated data of each of the plurality of digital twins with one or more artificial intelligence (AI) based models and one or more business objectives; and determine actionable business intelligence, based on the generated business knowledge, for building a knowledge based actionable intelligent enterprise system.

In one embodiment, the present disclosure discloses a non-transitory computer readable medium for building an actionable knowledge based intelligent enterprise system. The medium comprises instructions that when processed by a processor causes a device to perform operations. The operations comprises identifying a plurality of digital sub-systems from a plurality of business processes of an enterprise system. Each of the plurality of digital sub-systems comprises a plurality of atomic business transactions, where each atomic business transaction comprises an atomic executable process that generates associated data comprising transactional data and behavioral data. The operations further comprises generating a plurality of digital twins for each of the plurality of digital sub-systems, where each digital twin comprising a pair formed between an atomic executable process of a digital sub-system and associated data. Further, the operations further include performing triangulated integration of the plurality of digital twins corresponding to a digital sub-system from the plurality of digital-sub-systems, for identifying intra-process and inter-process correlation between the atomic executable process and associated data constituting each of the generated plurality of digital twins. The correlation comprises generation of business knowledge by alignment of the associated data of each of the plurality of digital twins with one or more artificial intelligence (AI) based models and one or more business objectives. The operations further comprises determining actionable business intelligence, based on the generated business knowledge, for building a knowledge based actionable intelligent enterprise system

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 illustrates a high-level architecture including an enterprise system and a Business Intelligence (BI) system, in accordance with some embodiments of the present disclosure;

FIG. 2a shows a block diagram illustrating interaction of BI system with digital twins of enterprise system, in accordance with some embodiments of the present disclosure;

FIG. 2b illustrates a first configuration of integration of data and process for building knowledge based intelligent enterprise system, in accordance with some embodiments of the present disclosure;

FIG. 2c illustrates a second configuration of integration of data and process for building knowledge based intelligent enterprise system, in accordance with some embodiments of the present disclosure;

FIG. 3 shows block diagram of BI system for building actionable knowledge based intelligent enterprise system, accordance with some embodiments of the present disclosure;

FIG. 4 shows a flowchart illustrating method steps for building actionable knowledge based intelligent enterprise system, in accordance with some embodiments of the present disclosure; and

FIG. 5 shows a block diagram of a general-purpose computer for building actionable knowledge based intelligent enterprise system, in accordance with an embodiment of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes, which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relates to a method and a business intelligence system for building actionable knowledge based intelligent enterprise system. The present disclosure proposes a solution which considers atomic executable process and its data as digital twins. Further, a triangulated integration of a plurality of digital twins is performed for identifying inter-process and intra-process correlation between the atomic executable process and its data. The correlation provides insights of business knowledge and helps in determining actionable business intelligence. The actionable business intelligence transforms the enterprise system into an intelligent enterprise system.

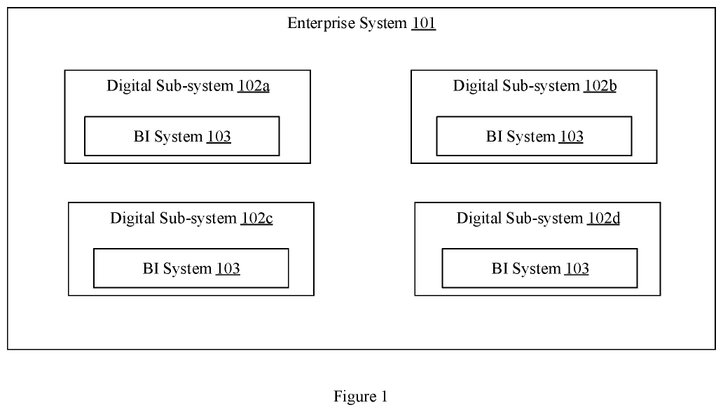

FIG. 1 shows an architecture comprising an enterprise system (101) and a Business Intelligence (BI) system (103). The enterprise system (101) may be used for serving various business functions such as sales, marketing, production, manufacturing, operations, finance, data science and analytics, etc. Examples of the enterprise system (101) may include, but not limited to, an Enterprise Resource Planning (ERP), system, a Human Resource (HR) system, a Supply Chain Management (SCM) system, a Customer Relationship Management (CRM) system, development platforms, network administrator tools, security monitoring systems, Content Management Systems (CMS), Business Analytics (BA) tools and the like.

The enterprise system (101) is configured to perform a plurality of business functions (processes). For example, the ERP system may have business functions such as accounting, inventory control, etc. Each business functions are implemented using one or more digital sub-systems (102a, 102b, 102c, 102d). For example, an accounting sub-system (e.g., 101a) in an ERP system. Although the FIG. 1 discloses only four sub-systems, the enterprise system (101) can have a plurality of sub-systems. The one or more sub-systems (102a, 102b, 102c, 102d) caters to a certain business functions linked to the enterprise system (101). The business functions are achieved through a plurality of transactions. Further, the enterprise system (101) comprises one or more databases (104a). The one or more database (104a) may be a system of storage which stores data required by the one or more digital sub-systems (102a, 102b, 102c, 102d) and the data generated by the one or more digital sub-systems (102a, 102b, 102c, 102d). For example, the one or more database (104a) may be a warehouse database which holds data related to a warehouse.

FIG. 1 also discloses the Business Intelligence (BI) system (103). The BI system (103) may be a configured to provide business intelligence to the enterprise system (101). The BI system (103) may use data, process and interactions between the data and the processes of the enterprise systems to derive actionable business knowledge and thereby determine actionable business intelligence based on the actionable business knowledge. Hence, the enterprise system (101) can be transformed into an intelligent system. The BI system (101) may be a computing unit which can be implemented inside the enterprise system (101). The BI system (103) may be provided access for the enterprise data and processes. In an embodiment, the BI system (103) may be hosted on an edge server or a cloud server. The BI system (103) may use data generated by the one or more digital sub-systems (102a, 102b, 102c, 102d) to derive the actionable business knowledge. In an embodiment, the BI system (103) may provide business intelligence as a Software as a Service (SaaS).

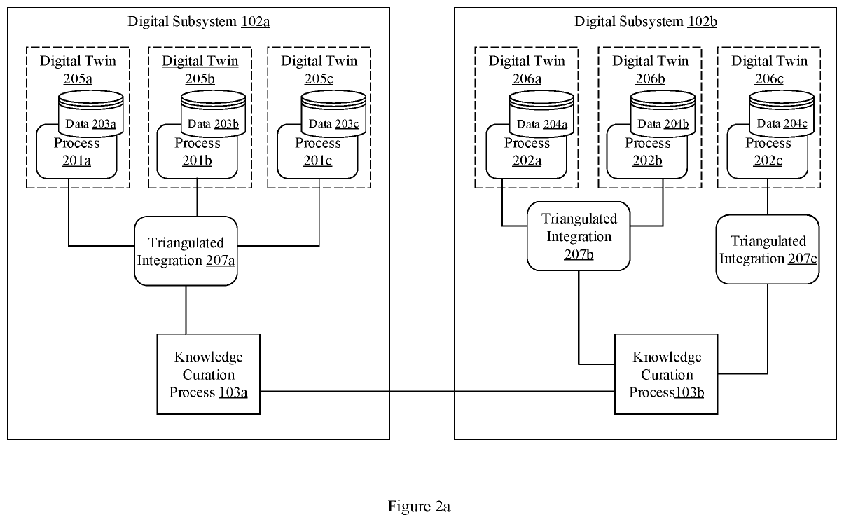

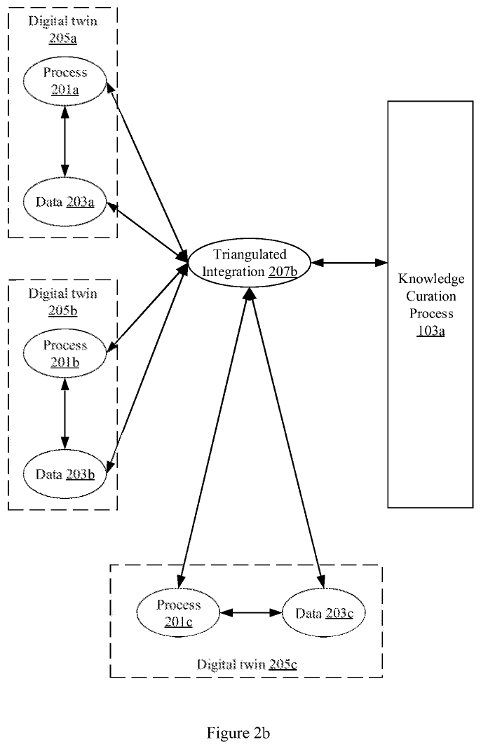

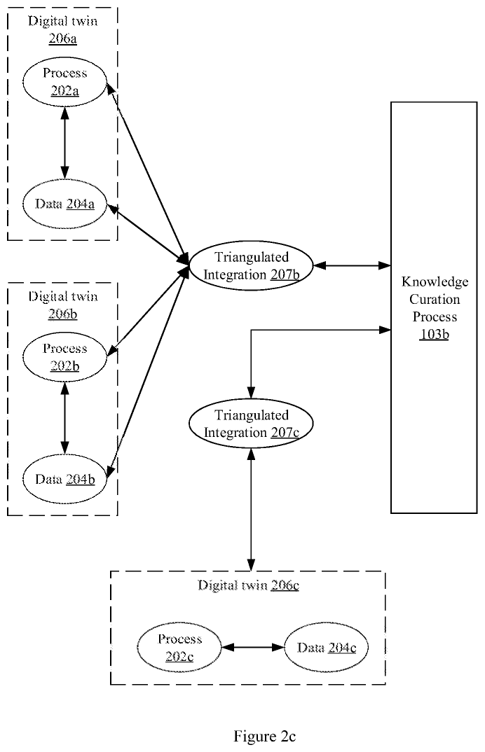

FIG. 2a shows a block diagram illustrating interaction of the BI system (103) with digital twins of enterprise system (101), in accordance with some embodiments of the present disclosure. Each digital subsystem is configured to perform a plurality of atomic business transactions and each atomic transaction comprises an atomic executable process and associated data. The digital sub-system (102a) may include a plurality of atomic executable processes (201a, 201b, 201c) and the digital sub-system (102b) may include a plurality of atomic executable processes (202a, 202b, 202c). The digital sub-systems (102a, 102b) may use the data present in database (collectively referred as 203 and 204). The BI system (103) may be implemented in each sub-system (102a, 102b, 102c, 102d). An instance of the BI unit (knowledge curator) may be implemented in the digital sub-system (102a) as knowledge curation process (103a) and may be implemented in the digital sub-system (102b) as knowledge curation process (103b). The collection of all knowledge curation process (103a, . . . 103n) is represented by the BI system (103). Each sub-system comprises a plurality of atomic business transactions and each transaction comprises the atomic executable process and associated data. In an embodiment, the associated data includes transactional data and behavioral data. Consider an example of flight booking transaction. Atomic transactions may be making a payment, selecting a seat, selecting meals and the like. Atomic transaction cannot be further divided. Transactional data in this example may include mode of payment, date and time of payment, and the like. Behavioral data in the above example may include special instructions by a customer regarding meals. The atomic executable process (e.g., 201a) and the associated data are made available to the BI system (103) via Application Program Interface (APIs). In an embodiment, the BI system (103) receives the requirements and technological roadmaps of the enterprise system (101) from business stakeholders. Thereafter, areas of upgrade, redesign, commissioning/decommissioning of assets and re-positioning of assets and/or resources are identified using the atomic executable processes and associated data of each digital sub-system. Further, the BI system (103) identifies the plurality of sub-systems (102a, 102b, 102c, 102d) of the enterprise system (101). For example, the knowledge curation process (103a) determines the digital sub-system it is deployed in based on analysis of process (201a, 201b, 201c) and data (203a, 203b, 203c) of the digital sub-system (102a).

In an embodiment, the BI system (103) generates a digital twin (e.g., 205a, 205b, 205c) for each digital sub-system (e.g., 102a). The digital twin (e.g., 205a) is generated as a pair comprising the atomic executable process (e.g., 201a) and the associated data (e.g., 203a). For any atomic business transaction, the atomic executable process and the associated data are co-joined, and due to the digital nature of the atomic executable process and the associated data, the association of the atomic executable process and the associated data is defined as the digital twin. In an embodiment, the plurality of digital twins (205a, 205b 205c, 206a, 206b, 206c) are generated for each of the plurality of atomic business transactions for each digital sub-system (102a, 102b). Each layer of the enterprise system (101) may comprise the plurality of digital twins (205a, 205b 205c, 206a, 206b, 206c). For example, in a client application, the different layers may include, an application layer, a web layer, a service layer, a logic layer, a data access layer and a database layer. In an embodiment, there may be one or more digital twins that enable interactions between the plurality of digital twins across layers.

Further, the BI system (103) performs triangulated integration (207a, 207b, 207c) of the plurality of digital twins corresponding to a digital sub-system from the plurality of digital sub-systems. Triangulated integration process (207a, 207b, 207c) means interaction between the atomic executable process (e.g., 201a) and the corresponding data (e.g., 203a). The knowledge curation process (103a, 103b) may have specific functions based on the digital sub-system (102a, 102b) they are hosted. That is, the data and process in each digital sub-system is different, thus the function of the knowledge curation process (103a, 103b) is dependent on type of data and processes present in the digital sub-system. The knowledge curation process (103a, 103b) may curate unique knowledge for respective digital sub-system (102a, 102b). FIG. 2b illustrates a first configuration of the triangulated integration (207a). The triangulated integration is performed within each sub-system (e.g., 102a) to identify intra-process correlation (as shown in FIG. 2b and FIG. 2c) and between sub-systems to identify inter-process correlation (not shown). In an embodiment, all the digital twins (205a, 205b, 205c) of a digital sub-system (102a) may interact with each other as shown in the FIG. 2b. In an embodiment, only certain digital twins (206a, 206b) may interact with each other as shown in the FIG. 2c. The knowledge curation process (103a) may use the triangulated integration to derive business knowledge. An example for intra-process correlation may include a flight ticketing process where the payment for the flight ticket can be made only when certain data such as passport number is provided. Hence, there is a correlation between the process of payment and the data required for successful payment, and the seat selection must be made for successful transaction. An example for inter-process correlation may include a flight ticketing process where the payment must be made, and the seat selection must be made for successful booking. Here, payment and seat selection may be individual atomic transactions. There exists a correlation between the process and the data of each transaction. The payment is based on the seat selected and the seat selection is associated with payment. Hence, the integration of the atomic executable process and its data is useful for generating business knowledge. For example, the BI system (103) may derive that customers prefer window seat the most and the center seat the least. Hence, the price for each seat may be set accordingly. Another associated example may include providing an offer while making payment using specific mode for selecting the center seat to promote center seat selection. The business knowledge may be generated by aligning the associated data of each digital twin using one or more Artificial Intelligence (AI) models. For example, decision tree, logistic regression, linear regression, clustering, classification etc. In an embodiment, the one or more AI models may perform data analytics to determine patterns in the associated data. Further, the one or more AI models may determine the trend or variations of the associated data with its atomic transaction process and other atomic transaction process. The variation is then aligned with the business objectives which are represented by the requirements and the technological road map of the enterprise system (101).

Further, the BI system (103) determines actionable business intelligence based on the generated business knowledge for building the actionable intelligent enterprise system. Once the BI system (103) generates the business knowledge, and align with the business objectives, the actionable business intelligence can be determined. Considering the previous example, when it is determined that customers prefer the window seat the most, the price of the window seat may be increased compared to aisle seat and the center seat. Likewise, business intelligence is curated using the business knowledge derived using the integration of process and data.

Example Scenario 1: Consider a bank Automated Teller Machine (ATM) A and a bank ATM B located at different locations. The atomic process may be cash withdrawal. The transactional data may include, date and time, customer card bank, amount entered, amount remaining in the ATM and the like. The behavioral data may include, number of transactions made by the customer, denominations preferred by the customer, bank card usage, customer feedback and the like. The BI system (103) determines that the cash withdrawal failure is high for a particular customer. Further, the BI system (103) determines that the time taken for money deposited in ATM B to reflect in customer account is 2-4 hours. The BI system (103) determines this correlates that whenever amount is deposited in a customer account in the ATM B, it takes 2-4 hours to reflect in the customer's account. In the meanwhile, if the customer try to withdraw money in the ATM A, then a failure occurs. Hence, the BI intelligent system (103) may take suggest a fix to lower the deposit time in the ATM B to rectify the failure in the ATM A.

Example Scenario 2: A bank has one ATM at a location and now decides to scale by deploying 10 more ATMs at different locations. The BI system (103) determines that the ATM server is deployed in a VM, and deployment of new ATMs will be challenging. Hence, the BI system (103) suggests cloud based containerized deployment which can be scaled easily with less challenges.

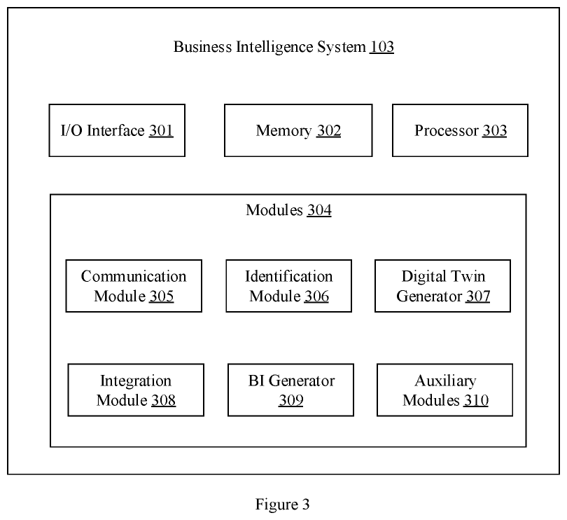

Reference is now made to FIG. 3 which shows a block diagram of the BI system (103). The computing unit (103) may include Central Processing Unit (“CPU” or “processor”) (303), a memory (302) storing instructions executable by the processor (303). The processor (303) may include at least one data processor for executing program components for executing user or system-generated requests. The memory (302) may be communicatively coupled to the processor (303). The computing unit (103) further includes an Input/Output (I/O) interface (301). The I/O interface (301) may be coupled with the processor (203) through which an input signal or/and an output signal may be communicated.

In some embodiments, the BI system (103) comprises modules (304). As described before, the plurality of knowledge curation process (103a, 103b) are collectively referred as BI system (103). The modules (304) may be stored within the memory (302). In an example, the modules (204) are communicatively coupled to the processor (303) and may also be present outside the memory (302) as shown in FIG. 3 and implemented as hardware. As used herein, the term modules (304) may refer to an application specific integrated circuit (ASIC), a Field Programmable Gate Array (FPGA), an electronic circuit, a processor (303) (shared, dedicated, or group), and memory (302) that execute one or more software or firmware programs, a combinational logic circuit, and/or other suitable components that provide the described functionality. In some other embodiments, the modules (304) may be implemented using at least one of ASICs and FPGAs. In an embodiment, an Input/Output (I/O) interface (301) may enable communication between the BI system (103) and the enterprise system (101).

In one implementation, the modules (304) may include, for example, a communication module (305), an identification module (306), a digital twin generator (307), an integration module (308), a BI generator (309) and auxiliary modules (310). It may be appreciated that such aforementioned modules (304) may be represented as a single module or a combination of different modules (304).

In an embodiment the communication module (305) is configured to facilitate communication between the BI system (103), and the one or more databases (104b, 104c) and the enterprise system (101). The communication module (305) facilitates in receiving the business requirements and technological roadmap from the enterprise system (101). The business requirements and the technological roadmap may be received as a digital document such as a word file, an excel file or as web data. Additionally, an enterprise system design may be provided. In an embodiment, the communication module (305) may parse the received information to obtain the digital content and store it. The data received from the one or more databases (104b, 104c) may include general survey data, public trend, media information and the like. The one or more databases (104b, 104c) may be external to the enterprise system (101). The communication module (305) may use server/client communication protocol to communicate with the enterprise system (101). In one embodiment, the communication module (305) can communicate with enterprise system (101).

In an embodiment, the identification module (306) is configured to identify the plurality of digital sub-systems (102a, 102b, 102c, 102d) of the enterprise system (101). In an embodiment, the enterprise system design may be used to identify the plurality of business sub-systems (102a, 102b, 102c, 102d). The enterprise system design may include data related to architecture of the enterprise system (101), high-level use cases, Infrastructure (IT) systems and technological systems used in the enterprise system (101). The enterprise system design may also include the individual atomic business transactions. The BI system (103) may monitor each business transaction to identify the plurality of business sub-systems (102a, 102b, 102c, 102d).

In an embodiment, the digital twin generator (307) is configured to generate a plurality of digital twins for each business transaction. The digital twin is a logical representation of the association of the atomic transaction process and its associated data.

In an embodiment, the integration module (308) is configured to perform triangulated integration (207a, 207b, 207c) of the plurality of digital twins (205a, 205b, 205c, 206a, 206b, 206c) for each of the plurality of digital sub-systems (102a, 102b, 102c, 102d). As illustrated in FIG. 2b, the triangulated integration (207a) is the interaction between the atomic transaction process and its associated data. In an embodiment, based on the requirements and the technological roadmap of the enterprise system (101) the integration module (308) deploys one or more of the following for the atomic process: API-fication, containerized microservices, batch process, mobile app, and serverless function to enable exchanging information between the plurality of atomic transaction processes, and the transaction data and the behavioral data. In an embodiment, based on the requirements and the technological roadmap of the enterprise system, the integration module (308) deploys one or more of the following for a storage of the associated data: Relational Database Management System (RDBMS), Non-Structured Query Language (No-SQL), document based, in-Memory database, and serverless compute. In an embodiment, the exchange of information between the plurality of atomic transaction processes and the transaction data and the behavioral data includes a data model (204) providing a feedback to about different types of data generated while executing the one or more transaction processes and a process model (203) provides a feedback about metrics of the one or more processes using the transaction data and the behavioral data.

The integration module (308) may implement the one or more AI models to determine the correlation within the digital twin to determine intra-process correlation. Further, the one or more AI models may determine inter-process correlation by correlating the different digital twins within a digital sub-system. In one embodiment, the correlation may be performed between different digital sub-systems as well. In an embodiment, the intra-process and inter-process correlation is identified by assessing parameters of the one or more atomic transaction processes and, the transaction data and the behavioral data. Further, a variation in the atomic transaction processes are determined due to variation in at least one of, transaction data and the behavioral data. Thereafter, a variation in the transaction data and the behavioral data due to variation in the one or more transaction processes is determined. Hence, the interaction between the process and data is determined.

In an embodiment, the BI generator (309) generates the business intelligence using the triangulated integration. In an embodiment, the BI generator (309) leverages future microservices based event driven architecture to enable digital transformation for the process model (203). Further, the BI generator (309) may determine a loosely coupled architecture for the data model (204). The atomic transaction processes are optimized by optimizing the transaction data and the behavioral data. The process is optimized by replacing legacy technology with alternate technology. For example, premise based architecture may be moved to cloud based architecture. Virtual Machine (VM) based deployments may be replaced with containerized deployment. Microservices and event driven architecture can be employed. Likewise, data can be optimized by altering the transaction data and/or the behavioral data. Data from one sub-system can be shared with other sub-systems to improve the outcome. Volume of data can be channelized to improve overhead on the sub-systems. In an embodiment, there may be various stages of data transformation. System of records—identification of legacy data stores which need to be migrated to target future-state database; System of integration—Extract, Transform, Load (ETL) process of cleaning legacy data, data transformation and loading data into target database; System of storage (Data Warehouse)—future-state database which will store all OLAP (Online analytical processing) data; System of reporting and analytics—tools and technologies that analyze OLAP data and uncover valuable data insights and reports; and System of presentation—different presentation capabilities (tabular, graph, heatmaps etc.) based on business needs.

In an embodiment, the auxiliary modules (310) may include, but not limited to a user a presentation module. The presentation module may present visualizations of the business intelligence determined by the BI module (309). In an embodiment, the presentation module may display analytics or it may display steps of transforming the legacy systems into digital systems.

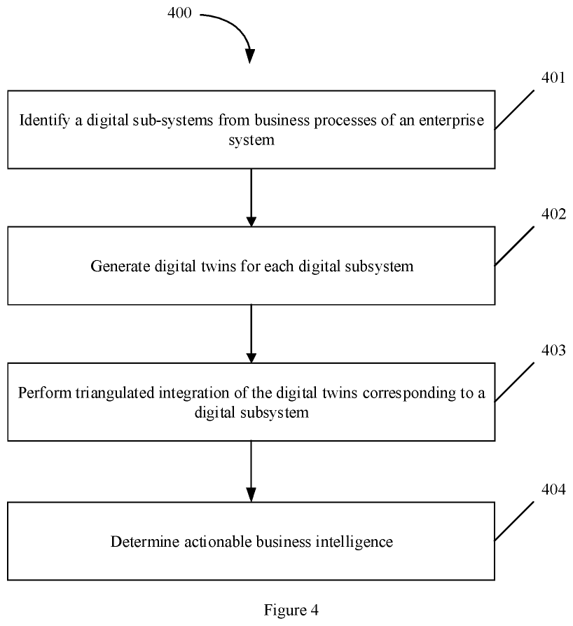

FIG. 4 shows a flowchart illustrating a method building actionable knowledge based intelligent enterprise system, in accordance with some embodiment of the present disclosure. The order in which the method (400) may be described is not intended to be construed as a limitation, and any number of the described method blocks may be combined in any order to implement the method. Additionally, individual blocks may be deleted from the methods without departing from the spirit and scope of the subject matter described herein. Furthermore, the method may be implemented in any suitable hardware, software, firmware, or combination thereof.

At step (401) identifying, by the BI system (103), the plurality of digital sub-systems from a plurality of business processes of an enterprise system, where each of the plurality of digital sub-systems comprises a plurality of atomic business transactions, wherein each atomic business transaction comprises an atomic executable process that generates associated data comprising transactional data and behavioral data.

At step (402), generating, by the BI system (103), a plurality of digital twins for each of the plurality of digital sub-systems, where each digital twin comprising a pair formed between an atomic executable process of a digital sub-system and associated data.

At step (403), performing, by the BI system (103), triangulated integration (207a, 207b, 207c) of the plurality of digital twins (205a, 205b, 205c, 206a, 206b, 206c) corresponding to a digital sub-system from the plurality of digital-sub-systems (102a, 102b, 102c, 102d). The triangulated integration (207a, 207b, 207c) helps in identifying intra-process and inter-process correlation between the atomic executable process and associated data constituting each of the generated plurality of digital twins. The correlation comprises generation of business knowledge by alignment of the associated data of each of the plurality of digital twins with one or more artificial intelligence (AI) based models and one or more business objectives.

At step (402), determining, by the BI system (103), actionable business intelligence, based on the generated business knowledge, for building a knowledge based actionable intelligent enterprise system.

In an embodiment, the present disclosure enables transformation of legacy system into future ready intelligent systems. Further, business intelligence based on integration of process and data provide new insights as a new dimension of information is available which was conventionally not available.

Computer System

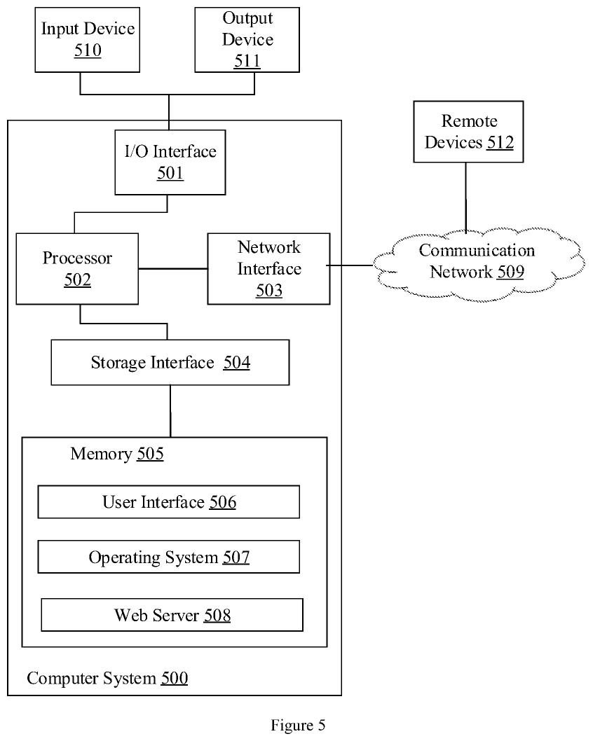

FIG. 5 depicts a block diagram of a general-purpose computer for building an actionable knowledge based intelligent enterprise system, in accordance with an embodiment of the present disclosure. The computer system (500) may comprise a central processing unit (“CPU” or “processor”) (502). The processor (502) may comprise at least one data processor. The processor (502) may include specialized processing units such as integrated system (bus) controllers, memory management control units, floating point units, graphics processing units, digital signal processing units, etc. The computer system (500) may be analogous to the BI system (101).

The processor (502) may be disposed in communication with one or more input/output (I/O) devices (not shown) via I/O interface (501). The I/O interface (501) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (501), the computer system (500) may communicate with one or more I/O devices. For example, the input device (510) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (511) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (500) is connected to the remote devices (512) through a communication network (509). The remote devices (512) may be the enterprise system (101). The processor (502) may be disposed in communication with the communication network (509) via a network interface (503). The network interface (503) may communicate with the communication network (509). The network interface (503) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (509) may include, without limitation, a direct interconnection, local area network (LAN), wide area network (WAN), wireless network (e.g., using Wireless Application Protocol), the Internet, etc. Using the network interface (503) and the communication network (509), the computer system (500) may communicate with the remote devices (512). The network interface (503) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network (509) includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, 3GPP and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor (502) may be disposed in communication with a memory (507) (e.g., RAM, ROM, etc. not shown in FIG. 5) via a storage interface (504). The storage interface (504) may connect to memory (507) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (507) may store a collection of program or database components, including, without limitation, user interface (506), an operating system (507), web server (508) etc. In some embodiments, computer system (500) may store user/application data, such as, the data, variables, records, etc., as described in this disclosure. Such databases may be implemented as fault-tolerant, relational, scalable, secure databases such as Oracle® or Sybase®.

The operating system (507) may facilitate resource management and operation of the computer system (500). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In some embodiments, the computer system (500) may implement a web browser (508) stored program component. The web browser (508) may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (508) may utilize facilities such as AJAX™, DHTML™, ADOBE® FLASH™, JAVASCRIPT™, JAVA™, Application Programming Interfaces (APIs), etc. In some embodiments, the computer system (500) may implement a mail server stored program component. The mail server may be an Internet mail server such as Microsoft Exchange, or the like. The mail server may utilize facilities such as ASP™, ACTIVEX™, ANSI™ C++/C #, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system (500) may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices, which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is, therefore, intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A method for building an actionable knowledge based intelligent enterprise system, the method comprising:
identifying, by a Business Intelligence (BI) system, a plurality of digital sub-systems from a plurality of business processes of an enterprise system, wherein each of the plurality of digital sub-systems comprises a plurality of atomic business transactions, wherein each atomic business transaction comprises an atomic executable process that generates associated data comprising transactional data and behavioral data;
generating, by the BI system, a plurality of digital twins for each of the plurality of digital sub-systems, wherein each digital twin comprises a pair formed between an atomic executable process of a digital sub-system and associated data;
performing, by the BI system, triangulated integration of the plurality of digital twins corresponding to a digital sub-system from the plurality of digital-sub-systems, for identifying intra-process and inter-process correlation between the atomic executable process and associated data constituting each of the generated plurality of digital twins, wherein the correlation comprises generation of business knowledge by alignment of the associated data of each of the plurality of digital twins with one or more artificial intelligence (AI) based models and one or more business objectives; and
determining, by the BI system, actionable business intelligence, based on the generated business knowledge, for building a knowledge based actionable intelligent enterprise system.

2. The method of 1, wherein performing triangulated integration comprises:
based on requirements and technological roadmap of the enterprise system, deploying one or more of the following for the atomic process: API-fication, containerized microservices, batch process, mobile app, and serverless function to enable exchanging information between the one or more transaction processes, and the transaction data and the behavioral data;
based on requirements and technological roadmap of the enterprise system, deploying one or more of the following for a storage of the associated data: Relational Database Management System (RDBMS), Non-Structured Query Language (No-SQL), document based, in-Memory database, and serverless compute.

3. The method of 2, wherein exchanging information comprises:
providing a feedback to about different types of data generated while executing the one or more transaction processes; and
providing a feedback about metrics of the one or more processes using the transaction data and the behavioral data.

4. The method of 1, wherein identifying intra-process and inter-process correlation comprises:
assessing parameters of the one or more transaction processes and, the transaction data and the behavioral data;
determining a variation in one or more transaction processes due to variation in at least one of, transaction data and the behavioral data, and
determining a variation in the transaction data and the behavioral data due to variation in the one or more transaction processes.

5. The method of 1, further comprises:
optimizing the one or more transaction processes, the transaction data and the behavioral data based on the business intelligence, wherein optimizing comprises at least:
replacing legacy technology used in the one or more transaction processes with one or more alternate technology; and
altering the transaction data and/or the behavioral data.

6. A Business Intelligence (BI) system for building an enterprise system, the BI system comprising:
a memory; and
one or more processors configured to:
identify a plurality of digital sub-systems from a plurality of business processes of an enterprise system, wherein each of the plurality of digital sub-systems comprises a plurality of atomic business transactions, wherein each atomic business transaction comprises an atomic executable process that generates associated data comprising transactional data and behavioral data;
generate a plurality of digital twins for each of the plurality of digital sub-systems, wherein each digital twin comprises a pair formed between an atomic executable process of a digital sub-system and associated data;
perform triangulated integration of the plurality of digital twins corresponding to a digital sub-system from the plurality of digital-sub-systems, for identifying intra-process and inter-process correlation between the atomic executable process and associated data constituting each of the generated plurality of digital twins, wherein the correlation comprises generation of business knowledge by alignment of the associated data of each of the plurality of digital twins with one or more artificial intelligence (AI) based models and one or more business objectives; and
determine actionable business intelligence, based on the generated business knowledge, for building a knowledge based actionable intelligent enterprise system.

7. The BI system of claim 1, wherein the one or more processors perform the triangulated integration, wherein the one or more processors are configured to:
based on requirements and technological roadmap of the enterprise system, deploy one or more of the following for the atomic process: API-fication, containerized microservices, batch process, mobile app, and serverless function to enable exchanging information between the one or more transaction processes, and the transaction data and the behavioral data;
based on requirements and technological roadmap of the enterprise system, deploy one or more of the following for a storage of the associated data: Relational Database Management System (RDBMS), Non-Structured Query Language (No-SQL), document based, in-Memory database, and serverless compute.

8. The BI system of claim 7, wherein the one or more processors are configured to exchange information, wherein the one or more processors are configured to:
provide a feedback to about different types of data generated while executing the one or more transaction processes; and
provide a feedback about metrics of the one or more processes using the transaction data and the behavioral data.

9. The BI system of claim 1, wherein the one or more processors identify intra-process and inter-process correlation, wherein the one or more processors are configured to:
assess parameters of the one or more transaction processes and, the transaction data and the behavioral data;
determine a variation in one or more transaction processes due to variation in at least one of, transaction data and the behavioral data, and
determine a variation in the transaction data and the behavioral data due to variation in the one or more transaction processes.

10. The BI system of claim 1, wherein the one or more processors are further configured to:
optimize the one or more transaction processes, the transaction data and the behavioral data based on the business intelligence, wherein optimizing comprises at least:
replace legacy technology used in the one or more transaction processes with one or more alternate technology; and
alter the transaction data and/or the behavioral data.

11. A non-transitory computer readable medium including instructions stored thereon that when processed by at least one processor cause a device to perform operations comprising:
identifying a plurality of digital sub-systems from a plurality of business processes of an enterprise system, wherein each of the plurality of digital sub-systems comprises a plurality of atomic business transactions, wherein each atomic business transaction comprises an atomic executable process that generates associated data comprising transactional data and behavioral data;
generating a plurality of digital twins for each of the plurality of digital sub-systems, wherein each digital twin comprises a pair formed between an atomic executable process of a digital sub-system and associated data;
performing triangulated integration of the plurality of digital twins corresponding to a digital sub-system from the plurality of digital-sub-systems, for identifying intra-process and inter-process correlation between the atomic executable process and associated data constituting each of the generated plurality of digital twins, wherein the correlation comprises generation of business knowledge by alignment of the associated data of each of the plurality of digital twins with one or more artificial intelligence (AI) based models and one or more business objectives; and
determining actionable business intelligence, based on the generated business knowledge, for building a knowledge based actionable intelligent enterprise system (101).

12. The non-transitory computer readable medium of claim 11, wherein causing the device to perform the triangulated integration (207a, 207b, 207c) comprises causing the device to perform operations comprising:
based on requirements and technological roadmap of the enterprise system, deploy one or more of the following for the atomic process: API-fication, containerized microservices, batch process, mobile app, and serverless function to enable exchanging information between the one or more transaction processes, and the transaction data and the behavioral data;
based on requirements and technological roadmap of the enterprise system, deploy one or more of the following for a storage of the associated data: Relational Database Management System (RDBMS), Non-Structured Query Language (No-SQL), document based, in-Memory database, and serverless compute.

13. The non-transitory computer readable medium of claim 12, wherein causing the device to exchange information, comprises causing the device to perform operations comprising:
providing a feedback to about different types of data generated while executing the one or more transaction processes; and
providing a feedback about metrics of the one or more processes using the transaction data and the behavioral data.

14. The non-transitory computer readable medium of claim 10, wherein causing the device to identify intra-process and inter-process correlation comprises causing the deice to perform operations comprising:
assessing parameters of the one or more transaction processes and, the transaction data and the behavioral data;
determining a variation in one or more transaction processes due to variation in at least one of, transaction data and the behavioral data, and
determining a variation in the transaction data and the behavioral data due to variation in the one or more transaction processes.

15. The non-transitory computer readable medium of claim 10, further causing the device to perform operations comprising:
optimizing the one or more transaction processes, the transaction data and the behavioral data based on the business intelligence, wherein optimizing comprises at least:
replacing legacy technology used in the one or more transaction processes with one or more alternate technology; and
altering the transaction data and/or the behavioral data.
